(19) United States
(12) Patent Application Publication
(10) Pub. No.: US 2024/0162725 A1
(43) Pub. Date: May 16, 2024

(54) A METHOD FOR BATTERY MANAGEMENT AND BATTERY SYSTEM

(71) Applicant: Nerve Smart Systems ApS, Roskilde (DK)

(72) Inventors: Gunnar ROHDE, Rødovre (DK); Jesper Boie RASMUSSEN, Birkerød (DK)

(21) Appl. No.: 18/552,009

(22) PCT Filed: Mar. 24, 2022
(86) PCT No.: PCT/DK2022/050057

§ 371 Date: Sep. 22, 2023

(30) Foreign Application Priority Data
Mar. 25, 2021 (DK) PA 2021 70135

(51) Int. Cl. H02J 7/00

(52) U.S. Cl. CPC H02J 7/0016; H02J 7/0048; H02J 7/005; H02J 7/00712; H02J 7/007194

(57) ABSTRACT

A method of battery management for managing a number of cells (2) comprising at least one set of cells (2) that are interconnectable in series to form a battery (5, 5′ 5″). The method comprises measuring parameters relating to the state of health, SoH, or of each cell (2) of said number of cells (2). The SoH of each cell (2) in said set of cells (2) are compared and at least one cell (2) having a poorer state of health than the remainder of the cells (2) and at least one cell (2) having a better state of health than the remainder of the cells (2) is identified. If a maximum state of charge, SoCmax, threshold has been reached for the at least one cell (2) having a better state of health during a charging cycle it is disconnected. If a minimum state of charge, SoCmin, threshold has been reached for the at least one cell (2) having a poorer state of health during a discharging cycle it is disconnected.

The present invention relates to management of battery systems.

All known (lithium-based) secondary batteries have a single cell nominal voltage below 5 V_{DC}. That is why most battery packs, modules, and strings in practical applications need a serial connection of a number of individual battery cells to meet major required nominal battery system voltages between 48 V_{DC} and 1.500 V_{DC}. For practical reasons, most battery systems are thereby based on modular and scalable approaches.

Especially lithium-based battery systems need continuously monitoring and supervision of their operating ranges and parameters due to their comparatively high energy density. According to Ohm's (voltage) law, a safe operation of the complete battery system is thereby dependent of a safe operation of each individual battery cell. That means, in modular and scalable battery systems every individual battery cell requires monitoring and supervision of its operating ranges and parameters.

Such monitoring and supervision functionalities are typically undertaken by a battery management system (BMS). The control procedures of battery management systems (BMS) are primarily based on two state estimations referred to as State of Charge (SoC) and State of Health (SoH). This applies for individual battery cells, battery packs and modules as well as for complete battery systems.

In literature definitions of SoC and/or SoH may vary, at least in some details but as will be understood from the following, at least the skilled person will appreciate that this is immaterial to the present invention.

Whereas the SoC makes primarily statements about useable capacity of battery cells, packs, modules, or systems, SoH indirectly makes statements about useable power of battery cells, packs, module, or systems since parameters describing the useable power are normally used to follow the development (degradation) of useable capacity over time. Therefore, sometimes two different SoH estimations are defined; an energy state of health (SoH_{nrg}) describing the decrease in maximum useable capacity and a power state of health (SoH_{pwr}) describing the decrease in maximum useable power of a battery cell, pack, module, or system. For sake of simplicity, the present description only considers a single SoH definition, cf. equation (2) below, but the invention may be implemented using other definitions accordingly.

$$SoC := \frac{Capacity}{{Capacity}_{max}} ; SoC ∈ [ 0 , 1 ] \qquad ( 1 )$$

Where Capacity is the actual (i.e. currently) usable capacity and Capacityₘₐₓ is the maximum usable capacity. A battery's (SoC) is a damped oscillation observable to describe its short-term performance.

$$SoH := \frac{{Capacity}_{max}}{{Capacity}_{max}^{BoL}} ; SoH ∈ [ 0 , 1 ] \qquad ( 2 )$$

Where Capacityₘₐₓ is the maximum usable capacity and Capacity_{BoLmax} is the maximum usable capacity at the battery's beginning of life (BoL). A battery's state of health (SoH) is a continuously decrease observable to describe its long-term performance.

Unfortunately, not all individual battery cells in a modular system have the same SoC and/or SoH—even if they are of the same type, coming from the same supplier, and from the same production. Typical reasons for inhomogeneities/imbalances in SoC between individual battery cells in the same battery pack, module, or system are: Inhomogeneities in raw material, tolerances in processing/production, differences in assembly and/or system integration, variations in operating parameters and/or ranges, unequal treatment during handling.

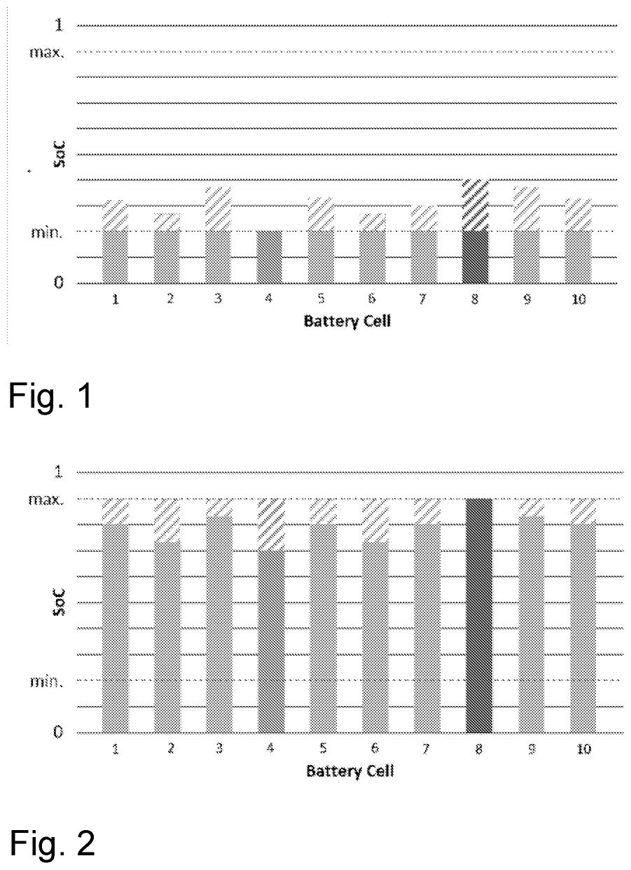

Most apparent during the operation of battery systems are inhomogeneities/imbalances in SoC between individual battery cells. One problem with inhomogeneities/imbalances in SoC can be exemplified by a battery pack with a number of individual battery cells in series connection. The example in FIG. 1 and FIG. 2 comprises ten cells for illustration. During discharging the weakest battery cell (#4) limits further discharging of the whole battery pack when reaching its minimum SoC first. Further discharge of the remaining battery pack would deeply discharge the weak battery cell which may cause serious problems with undervoltage, cf. FIG. 1. During charging, on the other hand, the strongest cell (#8) limits further charging of the whole battery when reaching its maximum SoC, df. FIG. 2. Further charging of the remaining battery pack would overcharge the string battery cell which may cause serious problems with overvoltage. Accordingly, a large part of the capacity of the battery pack cannot be used because of inhomogeneities/imbalances in SoC—and this applies to every charging/discharging-cycle of the battery pack. Accordingly, the hashed area of the columns corresponding to capacity of each cell are not properly utilized for the remaining cells due to the inhomogeneity of cells #4 and #8.

The prior art comprises a variety of technical solutions for SoC equalisation within battery packs or modules exist to limit and/or overcome the problem of imbalances and/or inhomogeneities between their individual battery cells. Different battery cell balancing methodologies present different advantages and disadvantages over each other, hence are suited and/or optimised for different applications of a battery system. In general, it can be summarised that:

Cell bypass methodologies, in particular bypass resistors, are most widely used due to their low cost, small size, and simple control.

Cell to cell, cell to module, and module to cell methodologies present relatively low voltage and/or current stress, especially in high-power applications.

Cell to cell methodologies, in particular switched capacitor and double-tiered switching capacitors, are efficient and good trade-offs.

For a more detailed description, comparison, and evaluation of the different battery cell equalisation methodologies reference is made to: Gallardo-Lozano, J. et. al.; Battery Equalization Active Methods; Journal of Power Sources; 2014; doi: 10.1016/j.jpowsour.2013.08.026.

US2016/0105042, as a specific example of prior art, describes four SoC balancing systems: Active balancing, passive balancing, charge shunting and charge limiting. All of these are well defined terms within the field of battery management systems (BMS) and are, in US2016/0105042, all clearly related exclusively to balancing of SoC as US2016/0105042 talks about delivering charge, removing charge, shunting charge, limiting charge or terminating charge. All of these directly influences on the SoC of the batteries but not their SoH. US2016/0105042 briefly mentions that SoH can be monitored and estimated but does not suggest any use of the knowledge about SoH thereby gained.

In this connection it is to be mentioned that (older) passive battery cell balancing/equalisation methodologies, for example fixed non-switchable by-pass resistors, are outdated state of the art in relation to the present invention.

The major disadvantage with the battery cell balancing methodologies mentioned above is that these methodologies exclusively try to equalise inhomogeneities/imbalances in SoC between individual battery cells—and do not take care for inhomogeneities/imbalances between the battery cell's SoH.

This is a serious causal problem since inhomogeneities/imbalances in the SoC between individual cell in a battery pack, module, and/or system is typically caused by inhomogeneous operating conditions (for example operating temperature) of the individual battery cells and/or imbalances in the battery cell's SoH. That is, by equalising the SoC between individual cells in a battery system, the above balancing methodologies only care for the effects any inhomogeneities/imbalances are causing, but not for the actual causes of the inhomogeneities/imbalances.

Quite the contrary is actually the case with the battery cell balancing methodologies mentioned above when SoC inhomogeneities/imbalances between individual battery cells are caused by inhomogeneities/imbalances in their SoH. If a weak cell in a battery system is demanding (active) cell balancing due to a lower SoH than the average in its battery pack or module, it is recommended to not only equalise the effect in state of charge SoC but also unload the weak battery cell (at least during equalising) to not increase the inhomogeneities/imbalances in SoH—which would cause an even higher demand for cell balancing in further use of that battery system. Some of the cell equalisation methodologies mentioned above, for example the module to cell methodologies, load the weak battery cell even more during equalisation; this quickly equalises the effect of the imbalances but actually increases the underlying cause for the imbalances between individual battery cells.

If SoC imbalances between individual cells are caused by inhomogeneous operating conditions (temperature and pressure gradients or the like) in the battery system, the prior art battery cell equalisation methodologies mentioned above have no direct influence on the operating conditions, hence take only care for the effect any inhomogeneities/imbalances are causing, too, but again not for the actual cause of the inhomogeneities/imbalances.

In addition to the general causal problems with only equalising inhomogeneities/imbalances in SoC between battery cells, the prior art battery cell balancing methodologies mentioned above present the following specific technical disadvantages.

Prior art dissipative battery cell balancing methodologies are principally limited in equalisation power/speed as well as they show higher demand for thermal management.

Prior art unidirectional battery cell balancing methodologies can only be exploited during charging or discharging of the battery system, hence weak and strong battery cell may still limit the useable capacity and/or power.

Prior art non cell-individual battery cell balancing methodologies are principally restricted in that they are not able to balance all possible inhomogeneities/imbalances in SoC to be expected in the battery system.

Based on this prior art it is the object of the present invention to provide an improved method for battery management overcoming the above drawbacks.

According to a first aspect of the invention this object is achieved by a method of battery management, said method comprising providing a number of cells interconnectable to form a battery pack, said number of cells comprising at least one set of cells that are interconnectable in series to form a battery, said method comprising measuring parameters relating to the state of health (SoH) of each cell of said number of cells, comparing the state of health of each cell in said set of cells, and identifying in said set of cells at least one cell having a poorer state of health than the remainder of the cells and at least one cell having a better state of health than the remainder of the cells, selectively disconnecting said at least one cell having a better state of health during a charging cycle if a maximum state of charge (SoCₘₐₓ) threshold has been reached for that cell and/or selectively disconnecting said at least one cell having a poorer state of health during discharging cycle if a minimum state of charge SoCₘᵢₙ threshold has been reached for that cell.

This provides a new method of battery management allowing for a new approach to battery cell balancing. By changing the focus of battery cell balancing from aiming to equalise inhomogeneities/imbalances in state of charge (SoC) to equalise inhomogeneities/imbalances in state of health (SoH), a battery management method taking not only care for the effect of inhomogeneities/imbalances, but also for the actual causes of the inhomogeneities/imbalances between individual battery cells is provided.

With a permanently balanced—or controlled—state of health (SoH) of all individual cells in a battery system, there are no weaker or stronger battery cells that reduce useable capacity and/or expected lifetime of a battery system, hence increase the system's total cost of ownership (TCO). Thus, the battery cells will typically not show inhomogeneities/imbalances in state of charge (SoC) that needs to be equalised. Even if individual cells in a battery system show inhomogeneities/imbalances in state of charge (SoC) it may be acceptable as long as the battery cell's state of health (SoH) is still balanced/equalised.

In other words, the present invention not only takes care of the effects of inhomogeneities/imbalances between individual battery cells inside battery packs, modules, or systems, but may predictively take care of the causes of the inhomogeneities/imbalances.

According to a preferred embodiment of the first aspect of the invention the method further comprises the measurement of parameters indicative of the state of charge (SoC) of each of said cells so as to determine whether said maximum state of charge (SoCₘₐₓ) threshold and/or said a minimum state of charge (SoCₘᵢₙ) threshold has been reached. Thus, in addition to the state of health measurements, estimates and predictions thereof the state of charge may also be monitored in order to protect against over charging or under voltage from over-discharging, by disconnecting the cell in question.

According to a further embodiment of the first aspect of the invention each cell is furthermore disconnected according to a predetermined scheme for performance of measurements of said parameters relating to the state of health during a charging cycle and/or a discharging cycle. This utilizes the configurable topology of the battery network to systematically during operation of the battery to check the state of health of individual cells, so that over a number of charging and discharging cycles each cell gets checked every once in a while.

According to another preferred embodiment the measured parameters relating to the state of health comprise one or more of cell voltage, current, or temperature.

According to a second aspect of the invention the object is achieved by a system comprising a battery with configurable topology and a computer control adapted for performing measurements of parameters indicative of state of health of the cells in the battery and configuring the battery in accordance with the method according to any one of the preceding claims.

The invention will now be described in greater detail based on nonlimiting exemplary embodiments and with reference to the figures, on which:

FIG. 1 is an example of the effect of inhomogeneities of battery cells in a battery on state of charge during discharge,

FIG. 2 is an example of the effect of inhomogeneities of battery cells in a battery on state of charge during charge,

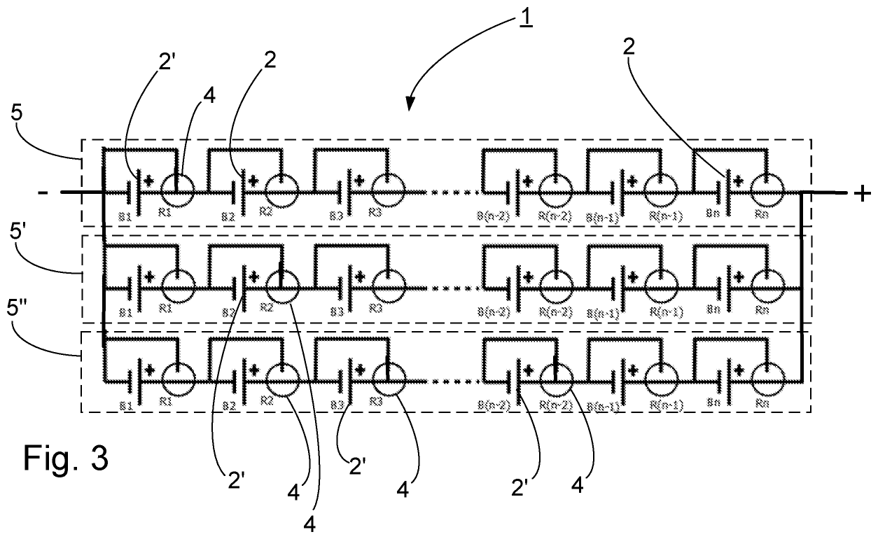

FIG. 3 is a simplified example of a battery with configurable topology as used in the present invention,

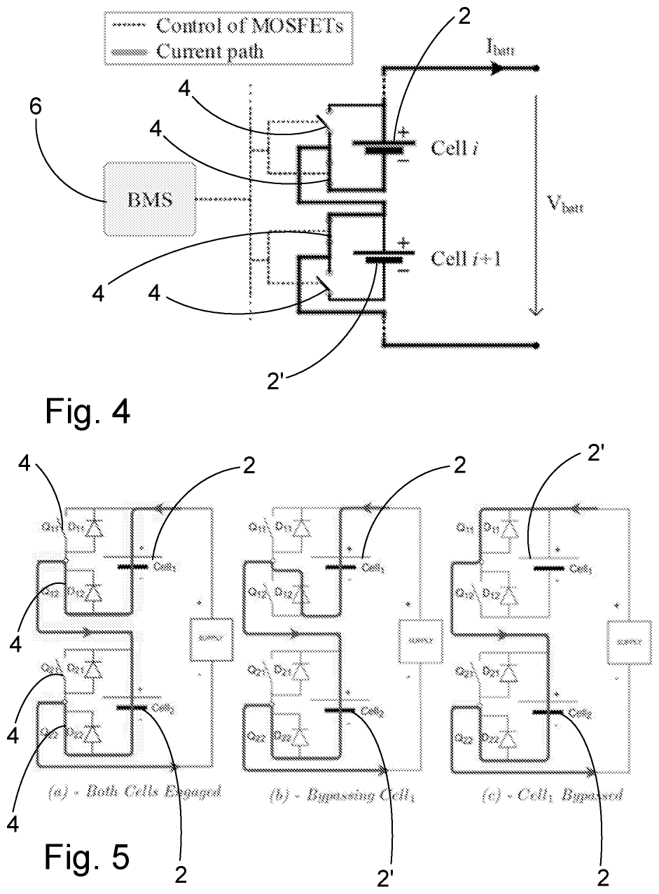

FIG. 4 is an example illustrating how cells may be controlled by the battery to configure the configurable topography, and

FIG. 5a-5c is an example illustrating the engaging and bypassing of cells during charging.

Turning first to FIG. 3 an example of a battery pack 1 with configurable topology is shown. The example is simplified for illustration purposes and shows only a limited number of cells 2 interconnectable to form the battery pack 1. In the applicant's currently preferred implementation there are 27 cells in 11 sets, i.e. a total of 297 cells 2, in the battery pack 1. As will be seen the illustrated the cells are series connectable in three strings, by means of individually controlled switches 4, so any of the strings 3 may define a first set of cells 2 that are interconnectable in series to form a first battery 5, and another set defines least one further number of cells 2 interconnectable in series to form at least one further battery 5′ in parallel with the first. As can be seen there is also a third string defining yet a further battery 5″. The first battery 5 and said further batteries 5′, 5″ are connected or connectable in parallel with said first battery 5 so as to form the battery pack 1. The individually controlled switches 4 need not be a single switch for each cell (as illustrated in FIG. 3) but would comprise two (as illustrated for two cells in FIG. 4), three or four switches, such as MOSFET transistors, or other solid state switches, for each cell 2, so as to allow not only shunting of a cell without short-circuiting it but also isolation thereof for test purposes. Such a configurable battery pack 1 is per se known from the applicant's prior application EP3529874 incorporated herein by reference.

As can be seen from FIG. 3 some of the cells 2′ are disconnected by their associated switches 4, whereas the majority of the cells 2 are connected in series in each of the three batteries.

This could be as part of a routine disconnection for testing the state of health of a cell 2 or for protecting the cell 2 against undervoltage during battery discharge or against overcharging during battery charge.

With the large number of cells in the batteries it is possible to routinely disconnect one cell 2 during one discharging or charging cycle for measurement without substantially affecting the output voltage, then another cell 2 during a next discharging or charging cycle, and so forth to routinely or periodically perform measurements on each and every cell 2, in turn allowing e.g. the state of health of each battery 5 to be known. Such measurement could involve cell voltage, maximum current, cell temperature, but also transient response when switching cells 2 in and out, and response to injected probe currents when a cell is isolated. This allows determination of e.g. an electrical equivalent circuit for the cell 2 and for assessment of the state of health of the cell 2. In this manner, for a system comprising a battery pack 1 with 11 sets of cells 2 forming batteries 5 of each 27 cells 2, each cell would be checked at least every 27'th discharging or charging cycle. More often if more than one cell 2 can be disconnected at a time and more often if measurements are performed both during discharging and charging cycles. This time would be independent of whether the battery pack comprises only a single set of cells 2 forming one single battery 5, three sets of batteries 5, 5′, 5″ as show, or 11 as mentioned.

It should be noted that measurements of parameters such as voltage, maximum current, temperature, resistance and capacity for determining the performance of individual battery cells are per se known. In this respect EP2660924 discloses a basic battery management system in which individual cells are monitored and upon deterioration simply disconnected from the battery one after the other until replacement of cells is necessary. There is no suggestion of selective and temporary disconnection for balancing and protection of the individual cells.

With knowledge about the state of health of each cell 2, e.g. gained as described above, the battery management system 6 according to the present invention will be able to selectively switch cells 2′ out of a battery 5 for a part of the discharging cycle for the battery 5 as illustrated the simplified examples in FIGS. 3 to 5, and thereby protect the cells 2′ with the poorest state of health, i.e. the weakest cells 2′, and the cells with the best state of health, i.e. the strongest cells 2′, during parts of the charging cycle of the battery 5, respectively. This evidently increases the stress on the remainder of the cells 2, which over the lifetime of the battery 5 equalizes the differences in state of health, and therefore leads to a better utilization of all the cells 2 in the battery 5.

That is to say, if during discharging a minimum state of charge threshold corresponding to the known state of health of a given cell 2 is reached the cell 2 is disconnected, i.e. bypassed, so that it does not discharge any further and thus not stressed any further, whereas the remainder of the cells 2 continue to discharge. Their capacity is thus better utilized as their discharge is not limited by the weakest cell 2. Over time this leads a better utilization of the cells 2.

Similar when, during charging, the cell 2 with the best state of health reaches a maximum state of charge threshold, e.g. fully charged, it is disconnected, cf. FIGS. 5a and 5c, whereas the remainder of the cells 2 continue to charge, in turn allowing them to charge further, unhindered by the cell 2 with the best state of health.

This is controlled by the battery management system 6 which forms a part of an overall system comprising the battery 5, 5′ 5″ with configurable topology. The battery management system 6 is preferably a computer or otherwise microprocessor controlled battery management system 6 adapted for performing measurements of parameters indicative of state of health of the cells 2 in the battery 5, 5′ 5″ and configuring the battery 5, 5′ 5″ in accordance with state of health of the cells 2 or for measurement. The battery management system 6 furthermore includes or has associated storage for the data such as the data from the measurement of each cell 2, state of health values, historical data about the deterioration of cells 2 etc. In particular so as to be able to set the predetermined threshold for state of charge (SoC) in view of the determined state of health (SoH) of each cell 2.

A working example for a set of 5 cells 2 will now be given.

Table 1 summarises the results from a single discharge-charge-cycle with the reference battery system. Before values of state of charge (SoC) and state of health (SoH) show that the battery system is almost fully charged at the beginning of the test cycle and that battery cell #1 is a bit stronger whereas battery cell #3 is a bit weaker than the average in the system. The battery cell has a rated nominal capacity of 1300 mAh, the load current used is standard about 0.8 C1 (˜1.05 A), and the balancing current of 105 mA is comparatively high (˜0.08 C1). In can be seen from Table 1 that all individual battery cells end up fully charged after the test cycle (the values of SoC (after) and SoH (after) are equal) and that strong/weak battery cells remain strong and weak, respectively. Nevertheless, the complete balancing increases the test cycle duration by about 25% (˜28 minutes) and about 3% (˜0.46 Wh) of the energy charged into the battery system lost due to balancing and/or remaining imbalances.

TABLE 1
Results from a single discharge-charge-cycle of the
reference battery system. The results are obtained
by simulation and are verified by experiment.

| Parameter | Cell 1 | Cell 2 | Cell 3 | Cell 4 |
|---|---|---|---|---|
| SoC (before) | 80% | 78% | 74% | 76% |
| SoH (before) | 96% | 92% | 88% | 92% |
| Cell Capacity | 1300 | | mAh | |
| Min. Voltage | 2.50 | | V_{DC} | |
| Max. Voltage | 3.60 | | V_{DC} | |
| Load Current | 1.05 | | A | |
| Shunt Voltage | 3.55 | | V_{DC} | |
| Balancing Current | 105 | | mA | |
| Overall Energy | ~15.31 | | Wh | |
| Balancing Time | ~28 | | min | |
| Energy Losses | ~0.46 | | Wh (~3%) | |
| SoC (after) | 96% | 92% | 88% | 92% |
| SoH (after) | 96% | 92% | 88% | 92% |

For validation of the proposed invention a reconfigurable battery with variable topology as shown in

Table 2 summarises the results from a single discharge-charge-cycle with a 5 cell reconfigurable battery system with variable topology. The individual cell capacity of 1050 mAh was chosen, so that the overall capacity of the reconfigurable battery system comes preferably close to the overall capacity of the 4 cell reference battery system. The additional 5th cell was chosen to be an average battery cell in the beginning with respect to state of charge (SoC) and state of health (SoH), so that also the reconfigurable battery system has a stronger battery cell (cell #1) and a weaker battery cell (cell #3). The applied voltage limits and the load current are the same as for the reference battery system. It can be seen in Table 2 that all individual battery cells end up fully charged after the test cycle (the values of SoC (after) and SoH (after) are equal) and that strong/weak battery cells remain strong and weak, respectively. But, compared to the test cycle with the reference battery system, the charging cycle with the reconfigurable battery system is not limited by balancing time and almost neglectable energy losses (˜0.01 Wh). The slightly higher overall energy charged in the reconfigurable battery system is due to the slightly higher overall capacity (˜5.250 mAh), compared to the 5.200 mAh of the reference battery system.

TABLE 2
Results from a single discharge-charge-cycle of a 5
cell reconfigurable battery system the results are
obtained by simulation and are verified by experiment.

| Parameter | Cell 1 | Cell 2 | Cell 3 | Cell 4 | Cell 5 |
|---|---|---|---|---|---|
| SoC (before) | 80% | 78% | 74% | 76% | 76% |
| SoH (before) | 96% | 92% | 88% | 92% | 92% |

| Cell Capacity | 1050 | mAh |
|---|---|---|
| Min. Voltage | 2.50 | V_{DC} |
| Max. Voltage | 3.60 | V_{DC} |
| Load Current | 1.05 | A |
| Shunt Voltage | n/a | |
| Balancing Current | n/a | |
| Overall Energy | ~15.45 | Wh |
| Balancing Time | n/a | |
| Energy Losses | ~0.01 | Wh (~0.07%) |

| | | | | | |
|---|---|---|---|---|---|
| SoC (after) | 96% | 92% | 88% | 92% | 92% |
| SoH (after) | 96% | 92% | 88% | 92% | 92% |

The comparison of a single discharge-charge-cycles with the reference battery system and the reconfigurable battery system already demonstrates the losses and/or limitations of conventional battery cell balancing methodologies, in particular using a battery cell bypass resistor. The values for state of health (SoH), however, in Table 11 and Table 2 are basically the same for both battery system before and after the discharge-charge-cycle. That looks very different after the test cycle is repeated for 1.000 times.

Table 3 summarises the results from 1.000 discharge-charge-cycles with the reference battery system. In comparison to the results in Table 1 from a single test cycle, it can be seen that the overall (useable) energy is with about 13.63 kWh circa 1.68 kWh lower than expected. This is due to general decrease in the state of health (SoH) of the system and non-useable energy due to (increasing) inhomogeneities/imbalances in state of charge (SoC) in each discharging-charging-cycle. Furthermore, the balancing time and the energy losses increased by about 34hrs and 65 Wh, respectively, over their expected values. This is basically due to the fact that the shunt resistors are used both more often and longer with the increasing number of test cycles. Comparing the state of health (SoH) values of the individual battery cells before and after the 1.000 test cycles shows that the strong battery cell (cell #1) remains the strong battery cell and that the weak battery cell (cell #3) remains the weak battery cell in the reference system. The variation in state of health (SoH), however, becomes significantly larger. And it can be seen that the weak battery cell (cell 3) is stressed more from the 1.000 test cycles than the strong battery cell (cell #1). In fact, the weak battery cell (cell #3) is already close to its end of life (EoL) which is often defined around 80% state of health (SoH), hence further use of the reference battery system may have a high risk of failure due to the state of health (SoH) from its weakest battery cell (cell #3).

TABLE 3
Results from 1.000 discharge-charge-cycles of the reference
battery system. The results are obtained by simulation.

| Parameter | Cell 1 | Cell 2 | Cell 3 | Cell 4 |
|---|---|---|---|---|
| SoC (before) | 80% | 78% | 74% | 76% |
| SoH (before) | 96% | 92% | 88% | 92% |

| | | |
|---|---|---|
| Cell Capacity | 1300 | mAh |
| Min. Voltage | 2.50 | V_{DC} |
| Max. Voltage | 3.60 | V_{DC} |
| Load Current | 1.05 | A |
| Shunt Voltage | 3.55 | V_{DC} |
| Balancing Current | 105 | mA |

| | |
|---|---|
| Overall Energy | ~13.63 kWh (−1.68 kWh) |
| Balancing Time | ~501 hrs (+34 hrs) |
| Energy Losses | ~525 Wh (+65 Wh) |

| | | | | |
|---|---|---|---|---|
| SoC (after) | 89% | 84% | 74% | 84% |
| SoH (after) | 89% | 84% | 74% | 84% |

Table 4 summarises the results from 1.000 discharge-charge-cycles with the reconfigurable battery system. In comparison to the results in Table 2 from a single test cycle, it can be seen that the overall (useable) energy is also about 0.8 kWh lower than expected. Nevertheless, this is about 50% reduced losses compared to those of the reference system in Table 3; for the reconfigurable battery system these losses can be completely assigned to the calendric and cyclic aging of the whole battery system as there is virtually no unused energy in the reconfigurable battery system in each discharging-charging-cycle. Furthermore, the energy losses stay with about 10 Wh on the same low level as there are for a single test cycle with the reconfigurable battery system. Comparing the state of health (SoH) values of the individual battery cells before and after the 1.000 test cycles for the reconfigurable battery system, too, demonstrates that all individual battery cells are virtually equalised not only in their state of charge (SoC) but also in their state of health (SoH). There is still the indication that cell #1 is the strongest and cell #3 the weakest, but this variation would probably be completely equalised during the next discharging-charging-cycles. More interesting is that none of the 5 individual battery cells 2 is fallen below 80% state of health (SoH); here, the risk for failure with further use of the reconfigurable battery system is not as high as with the reference battery system. The numbers in Table 4 also indicate that all the 5 individual battery cells in the reconfigurable battery system may reach their end of life (EoL) at about the same time. Hence, not (useable) lifetime capacity is left in some of the battery cells 2 when the whole battery system fails due to a single cell failure.

TABLE 4
Results from 1.000 discharge-charge-cycles of the reconfigurable
battery system. The results are obtained by simulation.

| Parameter | Cell 1 | Cell 2 | Cell 3 | Cell 4 | Cell 5 |
|---|---|---|---|---|---|
| SoC (before) | 80% | 78% | 74% | 76% | 76% |
| SoH (before) | 96% | 92% | 88% | 92% | 92% |

| Cell Capacity | 1050 | mAh |
|---|---|---|
| Min. Voltage | 2.50 | V_{DC} |
| Max. Voltage | 3.60 | V_{DC} |
| Load Current | 1.05 | A |
| Shunt Voltage | n/a | |
| Balancing Current | n/a | |
| Overall Energy | ~14.65 kWh (−0.8 kWh) | |
| Balancing Time | n/a | |
| Energy Losses | ~10 | Wh (~0.07%) |

| | | | | | |
|---|---|---|---|---|---|
| SoC (after) | 84% | 83% | 82% | 83% | 83% |
| SoH (after) | 84% | 83% | 82% | 83% | 83% |

It is interesting to point out that the mean average state of health (SoH) between the individual battery cells 2 is very close to each other with the two different types of battery systems (˜83%). So, the main disadvantages and/or limitations for the reference battery system with the conventional battery cell balancing method is solely caused by the increasing gradient of the state of health (SoH) between the individual battery cells 2.

The invention has now been described based on exemplary embodiments. It should be understood that the skilled person will understand that many other embodiments and variants of the invention exist. In particular, the invention is not limited to any specific number of cells 2 in each battery, and likewise not to any specific number of batteries in the battery pack of the overall system. It should also be noted that the protection of weak batteries against over-discharge is in principle independent from the protection of strong batteries against overcharging. It will, however, make most sense to implement both in order to achieve best possible cell equalisation and balancing over time.

1. A method of battery management, said method comprising providing a number of cells interconnectable to form a battery pack, said number of cells comprising at least one set of cells that are interconnectable in series to form a battery,
said method comprising measuring parameters relating to the state of health (SoH) of each cell of said number of cells,
comparing the state of health of each cell in said set of cells, and
identifying in said set of cells at least one cell having a poorer state of health than the remainder of the cells and at least one cell having a better state of health than the remainder of the cells,
selectively disconnecting said at least one cell having a better state of health during a charging cycle if a maximum state of charge (SoCₘₐₓ) threshold has been reached for that cell and/or selectively disconnecting said at least one cell having a poorer state of health during discharging cycle if a minimum state of charge SoCₘᵢₙ threshold has been reached for that cell.

2. A method according to claim 1, further comprising the measurement of parameters indicative of the state of charge (SoC) of each of said cells so as to determine whether said maximum state of charge (SoCₘₐₓ) threshold and/or said a minimum state of charge (SoCₘᵢₙ) threshold has been reached.

3. A method according to claim 1, wherein according to a predetermined scheme each cell is furthermore disconnected for performance of measurements of said parameters relating to the state of health during a charging cycle and ore a discharging cycle.

4. A method according to claim 1, wherein the measured parameters relating to the state of health comprise one or more of cell voltage, current, or temperature. Measuring these parameters at and during disconnection of cells allows a determination of the state of health of the individual cells.

5. A system comprising a battery with configurable topology and a computer controlled battery management system adapted for performing measurements of parameters indicative of state of health of the cells in the battery and configuring the battery in accordance with the method according to claim 1.
